(19) United States
(12) Patent Application Publication
(10) Pub. No.: US 2005/0210342 A1
(43) Pub. Date: Sep. 22, 2005

(54) Recognition of reduced service capacities in a communication network

(76) Inventor: Josef Schwagmann, Bangalore (IN)

Correspondence Address: Siemens Corporation;Intellectual Property Department, 170 Wood Avenue South, Iselin, NJ, 08830, US

(21) Appl. No.: 10/520,716

(22) PCT Filed: Jul. 9, 2003
(86) PCT No.: PCT/DE03/02302

§ 371 Date: Jun. 6, 2005

(30) Foreign Application Priority Data
Jul. 10, 2002 (DE) 10231150.1

(51) Int. Cl. G06F 11/00

(52) U.S. Cl. 714/704

(57) ABSTRACT

On establishing and/or changing a service, information relating to the functional properties and topological arrangement of network elements relevant to provision of said service is stored in a network element database and allocated to the service The information stored in the network element database is made available to a service quality and/or an error monitoring device. Recorded measured values are compared with the information stored in the network element database by the service quality and/or the error monitoring device for inadmissible deviations. On an inadmissible deviation a message is generated about a reduced server capacity giving details of the service concerned.

### CROSS REFERENCE TO RELATED APPLICATIONS

This application is the US National Stage of International. Application No. PCT/DE2003/002302, filed Jul. 9, 2003 and claims the benefit thereof. The International Application claims the benefits of German application No. 10231150.1 filed Jul. 10, 2002, both applications are incorporated by reference herein in their entirety.

### FIELD OF THE INVENTION

The present invention relates to a method for recognizing reductions in service capacity in a communication network, a communication network control and monitoring system, a control program for a communication connection management device and a control program for a service quality and/or error monitoring device.

### BACKGROUND OF THE INVENTION

In the telecommunications market, numerous services, in particular Internet services, are provided for customers by network operators. Services provided by network operators are subdivided into different quality-of-service levels in order to fulfill customer needs for guaranteed levels of service quality and to differentiate the network operators from their competitors. For example, services are provided at low cost for private customers and services which are more extensive in scope are provided at higher cost for business customers. The extended scope of services consists, for example, in ensuring a high level of availability and a low level of data loss. For this purpose, service level agreements (SLAs) are concluded between network operator and customer in which the scope and quality of services to be provided for the customer are stipulated. Particular importance is attached here to demonstrating compliance with the service level agreement to the customer. For proof of this kind, services have to be monitored in order, for example, to record failures and to determine the availability of a service. In addition, measurements are performed in order to record service quality parameters such as data loss. The provision of services is therefore not restricted purely to administering service parameters such as bandwidth or call number, but service-specific additional functions are also controlled.

In order to keep the impact of non-compliance with a service level agreement to a minimum both for the network operator and for the customer, the reliable and fast recognition of reductions in service capacity is indispensable.

### SUMMARY OF THE INVENTION

The object of the present invention is to establish a method which enables the reliable and fast recognition of reductions in service capacity and to indicate a suitable implementation of the method and a suitable communication network control and monitoring system for performing the method.

This object is achieved by the claims. Advantageous further developments of the method according to the invention are specified in the dependent claims.

An essential prerequisite for the reliable recognition of reductions in service capacity is that, according to the invention, information which describes the functional properties and topological arrangement of network elements relevant to provision of a service, including their assignment to the respective service, is, through establishment or modification of the service, made available to a service quality or error monitoring device. The result of this is that the information made available can be compared by the service quality or error monitoring device with recorded measured values, essentially immediately after their recording, for inadmissible deviations. On this basis, evidence about reductions in service capacity can then be derived quickly and not merely in retrospect, since the assignment to the service concerned in each case is already available in the service quality or error monitoring device. Evidence about reductions in service capacity can then be reported without delay for the purposes of rectifying the reduction in service capacity or for reporting purposes.

Use of a data stock, created upon establishment or modification of the service for service quality or error monitoring, leads, even at the outset, to avoidance of the use of irrelevant data. This yields increased reliability in the recognition of reductions in service capacity.

### BRIEF DESCRIPTION OF THE DRAWINGS

An embodiment of the present invention will be explained in more detail below with reference to the drawings, in which:

FIG. 1 shows a schematic representation of a communication network control and monitoring system,

FIG. 2 shows a diagram for representing signal flows on establishment or modification of a service, and

FIG. 3 shows a diagram for representing signal flows during an error occurrence.

### DETAILED DESCRIPTION OF THE INVENTION

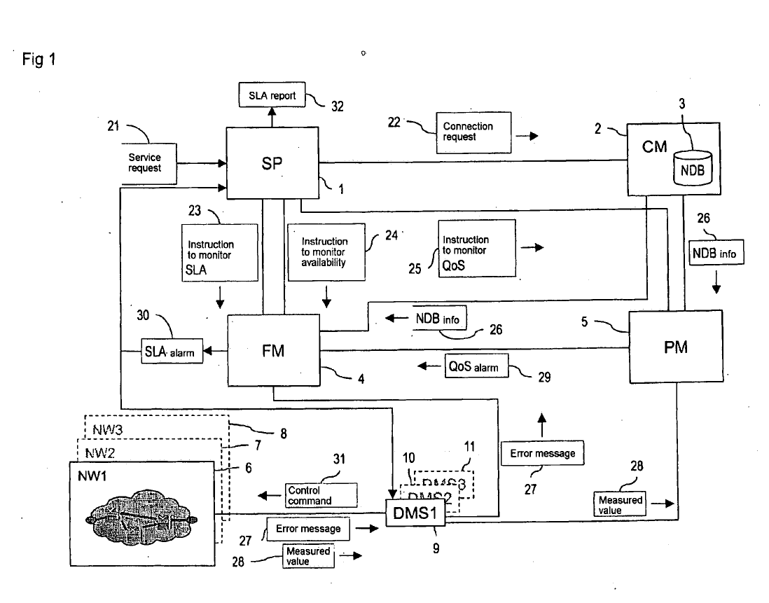

The communication network control and monitoring system represented schematically in FIG. 1 comprises a service providing device 1, a communication connection management device 2, an error monitoring device 4 and a service quality monitoring device 5. The service providing device 1 is provided for establishing or modifying services. Here, the service providing device 1 receives messages 21 containing service requests and converts these into messages 22 containing connection requests which are transmitted to the communication connection management device 2.

The communication connection management device 2 is provided for storing information which describes the functional properties and topological arrangement of network elements relevant to provision of a service. This information is assigned to the respective service and stored in a network element database 3 assigned to the communication connection management device 2. The network elements relevant to provision of a service include for example network access points, terminal connections and line connections along an end-to-end network path between two service access points. Functional properties of network elements are for example bandwidth, communication protocols supported and switching technologies used. The description of the topological arrangement of network elements comprises subdivision of the network elements into nodal network elements, such as measuring points and switching points, and edge network elements, such as line connections, and processing as topological information in accordance with a node-edge model. The information stored in the network element database 3 is made available on request to the error monitoring device 4 and the service quality monitoring device 5.

Upon the establishment or modification of a service, a message is transmitted from the service providing device 1 to the error monitoring device 4 with an instruction to monitor the availability of network elements which are specified as relevant to provision of the respective service. Correspondingly, a message 25 is transmitted to the service quality monitoring device 5 with an instruction to monitor the quality of the service. By means of these monitoring instructions, the error monitoring device 4 and the service quality monitoring device 5 are prompted to compare error messages 27 and measured values 28 recorded in subnetworks 6,7,8, said error messages and measured values being forwarded to the error monitoring device 4 or the service quality monitoring device 5 via a network control system 9,10,11 assigned to the respective subnetwork, with the information stored in the network element database 3 for inadmissible deviations. For this purpose, appropriate network element database information is requested by the error monitoring device 4 or the service quality monitoring device 5 and transmitted to said devices as messages 26. In the case of an inadmissible deviation from the information stored in the network element database 3, a message 29,30 about a reduction in service capacity is generated by the error monitoring device 4 or service quality monitoring device 5, giving details of the service concerned.

The monitoring of availability and of service quality is carried out in accordance with a service level agreement concluded between a customer and a network operator. Therefore, only information relating to the network elements specified by a service level agreement as relevant to provision of a service is stored in the network element database 3. Furthermore, error messages or measured values are recorded only in relation to the network elements specified by the service level agreement as relevant to provision of the service. To monitor the provisions stipulated under a service level agreement, on establishment or modification of a service a message 23 is transmitted from the service providing device 1 to the error monitoring device 4 with an instruction to monitor a service level agreement. This means that recording of error messages or measured values relating to network elements specified by the service level agreement as relevant to provision of a service is prompted as soon as the service concerned is established or modified.

If the evaluation of a measured value 28 in the service quality monitoring device 5 indicates that a network element is being operated outside an admissible operating range, then an alarm message 29 is transmitted from the service quality monitoring device 5 to the error monitoring device 4 about a violation of a service quality criterion and converted there into an alarm message 30 about a violation of a service level agreement. An error message 27 is converted in the error monitoring device 4 directly into an alarm message about the violation of a service level agreement. The alarm message 30 contains a statement about the availability of the service or the quality of the service and is transmitted for the purposes of rectifying the reduction in service capacity to a network control system 9,10,11 which is assigned to the subnetwork 6,7,8 in which an error or a violation of the service quality criterion has occurred. The alarm message 30 is converted by the respective network control system 9,10,11 into a control command 31 which is transmitted as a message for rectifying the reduction in service capacity to a selected control device, not explicitly shown, in the respective subnetwork 6,7,8. To rectify the reduction in service capacity, reconfiguration of the network element affected by rectification of the reduction in service capacity is carried out by means of the respective network control system 9, 10, 11 accessing the information stored in the network element database 3. This also applies to configuration of a network element on establishment, modification or deletion of a service.

The alarm message 30 about a violation of a service level agreement is likewise transmitted to the service providing device 1. There, it is updated with customer data and converted into a report 32 about compliance with or violation of a service level agreement.

Implementation of the process steps carried out in the service providing device 1, the communication connection management device 2, the error monitoring device 4 and the service quality monitoring device 5 is in each case carried out by a control program provided for the service providing device 1, the communication connection management device 2, the error monitoring device 4 and the service quality monitoring device 5. The respective control program runs on a data processing system assigned to the service providing device 1, the communication connection management device 2, the error monitoring device 4 or the service quality monitoring device 5. Depending on the application case, it is also possible to use a shared data processing system on which the aforesaid control programs run either separately or as combined control programs.

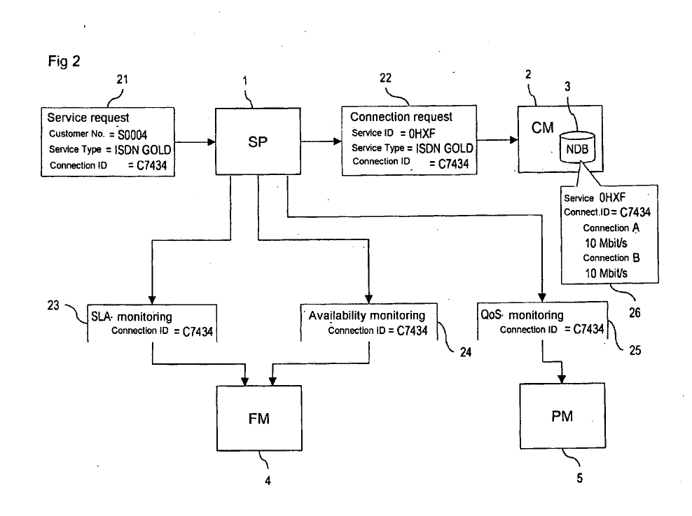

FIG. 2 shows in greater detail the signal flows, already shown in FIG. 1, upon the establishment or modification of a service. The message 21 with the service request 21 contains details such as customer number, service type or an identifier of the connection to be provided in the network for the respective service. The connection here is essentially identified by a start point and end point of a service access. The information about the service request contained in the message 21 is assigned in the service providing device 1 to previously stored customer data and converted into a message 22 about a connection request. This message 22 is transmitted to the communication connection management device 2 and contains details such as a unique service identifier, the service type and the connection identifier. A data record for the network element database 3 is constructed in the communication connection management device 2 from the message 22 about a connection request. This data record contains the service identifier, the connection identifier and details about subconnections, whose characteristic functional properties, such as data rate and latency time, are also stored in the network element database 3. With the establishment or modification of the service, messages 23,24,25 are transmitted with monitoring instructions to the error monitoring device 4 or the service quality monitoring device 5. In order to link the respective monitoring instructions 23,24,25 to data records of the network element database 3, the messages 23,24,25 contain details about the connection identifier as a linking element to the data records of the network element database 3.

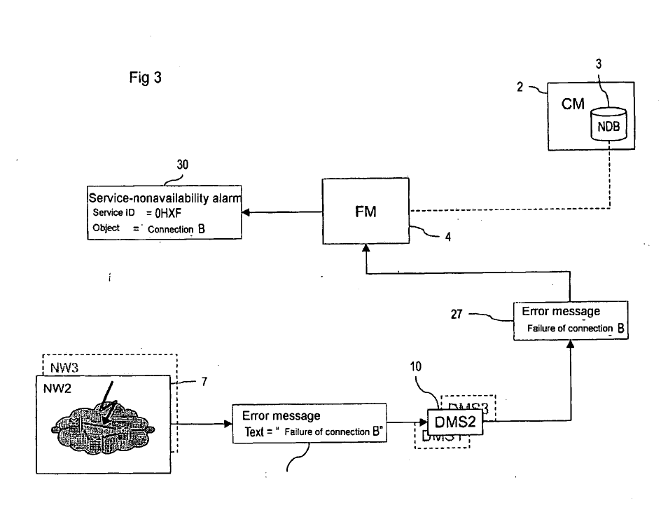

In the event of an error, for example the failure of a connection, an error message 27 is transmitted by a monitoring device, not shown in detail, in the subnetwork 7 concerned to the network control system 10 assigned to the subnetwork 7 concerned, evaluated there and then forwarded to the error monitoring device 4 (FIG. 3). The error monitoring device 4 matches the details contained in the error message 27 with the information contained in the network element database 3 and generates an alarm message 30 about service nonavailability 30, where the failure of the connection affects a service level agreement. The alarm message 30 about the service nonavailability contains details about the respective service identifier and a designation of the nonavailable object or network element.

Application of the present invention is not restricted to the embodiment described here.

The invention further comprises a control or computer program for a communication connection management device of a communication network control and monitoring system, the system comprising:
a service providing device for establishing and/or modifying a service,
a communication connection management device for storing information relating to the functional properties and topological arrangement of network elements relevant to provision of the service in a network element database assigned to the communication connection management device, for assigning this information to the service and for making available the information stored in the network element database to a service quality and/or error monitoring device, and
a service quality and/or error monitoring device for comparing recorded measured values with the information stored in the network element database for inadmissible deviations and, in the event of an inadmissible deviation, for generating a message about a reduction in service capacity giving details of the service concerned, wherein
   said control or computer program being loadable into a working memory of a data processing system assigned to the communication connection management device and having at least one code section, on execution of which
on the establishment and/or modification of a service, information relating to the functional properties and topological arrangement of network elements relevant to provision of the service is stored in a network element database and assigned to the service,
the information stored in the network element database is made available to a service quality and/or error monitoring device, when the control or computer program is running in the data processing system.

The invention comprises also a control or computer program for a service quality and/or error monitoring device of a communication network control and monitoring system the system comprising:
a service providing device for establishing and/or modifying a service,
a communication connection management device for storing information relating to the functional properties and topological arrangement of network elements relevant to provision of the service in a network element database assigned to the communication connection management device, for assigning this information to the service and for making available the information stored in the network element database to a service quality and/or error monitoring device, and
a service quality and/or error monitoring device for comparing recorded measured values with the information stored in the network element database for inadmissible deviations and, in the event of an inadmissible deviation, for generating a message about a reduction in service capacity giving details of the service concerned, wherein
   said control or computer program being loadable into a working memory of a data processing system assigned to the service quality and/or error monitoring device and having at least one code section, on execution of which
recorded measured values are compared with information relating to the functional properties and topological arrangement of network elements relevant to provision of a service, said information being stored in a network element database, for inadmissible deviations,
in the event of an inadmissible deviation, a message is generated about a reduction in service capacity, giving details of the service concerned
   when the control or computer program is running in the data processing system.

1-10. (canceled)

11. A method for recognizing reductions in an expected service capacity in a communication network, comprising:
storing information relating to functional properties and topological arrangement of network elements relevant to the provision of a service in a network element database and assigning the information to the service, on establishment and/or modification of the service;
providing the information stored in the network element database for a service quality and/or error monitoring device;
comparing recorded measured values to the information stored in the network element database by the service quality and/or error monitoring device regarding inadmissible deviations; and
generating a message about a reduction in the expected service capacity in the event of an inadmissible deviation

12. The method according to claim 11, further comprising:
storing information relating to network elements specified as relevant to the provision of the service with regard to a service level agreement in the network element database; and
recording measured values relating to the network elements specified as relevant to the provision of the service with regard to the service level agreement.

13. The method according to claim 11, wherein the message contains a statement about service quality and/or service availability.

14. The method according to claim 12, wherein the message contains a statement about service quality and/or service availability.

15. The method according to claim 11, wherein the message about a reduction in service capacity is transmitted to a network control system for rectification of the reduction in service capacity.

16. The method according to maim 12, wherein the message about a reduction in service capacity is transmitted to a network control system for rectification of the reduction in service capacity.

17. The method according to claim 13, wherein the message about a reduction in service capacity is transmitted to a network control system for rectification of the reduction in service capacity.

18. The method according to claim 11, wherein the information stored in the network element database describes admissible operating ranges of the network elements.

19. The method according to claim 12, wherein the information stored in the network element database describes admissible operating ranges of the network elements.

20. The method according to claim 13, wherein the information stored in the network element database describes admissible operating ranges of the network elements.

21. The method according to claim 15, wherein the information stored in the network element database describes admissible operating ranges of the network elements.

22. The method according to claim 11, wherein on the establishment, modification and/or deletion of a service, network elements affected by the establishment, modification and/or deletion are configured by a network control system accessing the information stored in the network element database.

23. The method according to claim 12, wherein on the establishment, modification and/or deletion of a service, network elements affected by the establishment, modification and/or deletion are configured by a network control system accessing the information stored in the network element database.

24. The method according to claim 13, wherein on the establishment, modification and/or deletion of a service, network elements affected by the establishment, modification and/or deletion are configured by a network control system accessing the information stored in the network element database.

25. The method according to claim 15, wherein on the establishment, modification and/or deletion of a service, network elements affected by the establishment, modification and/or deletion are configured by a network control system accessing the information stored in the network element database.

26. The method according to claim 11, wherein on the establishment and/or modification of the service a recording of measured values relating to network elements specified by the service level agreement as relevant to provision of the service is initiated.

27. The method according to claim 12, wherein on the establishment and/or modification of the service a recording of measured values relating to network elements specified by the service level agreement as relevant to provision of the service is initiated.

28. A communication network control and monitoring system, comprising:
a service providing device for establishing and/or modifying a service;
a communication connection management device for storing information relating to the functional properties and topological arrangement of network elements relevant to provision of the service in a network element database assigned to the communication connection management device, for assigning this information to the service and for providing the information stored in the network element database to a service quality and/or error monitoring device; and
a service quality and/or error monitoring device for comparing recorded measured values with the information stored in the network element database for inadmissible deviations and, in the event of an inadmissible deviation, for generating a message about a reduction in service capacity giving details of the service concerned.

29. The communication network control and monitoring system according to claim 28, further comprising a control program for the communication connection management device, wherein
the control program is loadable into a working memory of a data processing system assigned to the communication connection management device and having at least one code section, on execution of which
on the establishment and/or modification of a service, information relating to the functional properties and topological arrangement of network elements relevant to provision of the service is stored in a network element database and assigned to the service, and
the information stored in the network element database is provided to a service quality and/or error monitoring device, when the computer program is running in the data processing system.

30. The communication network control and monitoring system according to claim 28, further comprising a control program for the service quality and/or error monitoring device, wherein
the control program being loadable into a working memory of a data processing system assigned to the service quality and/or error monitoring device and having at least one code section, on execution of which
recorded measured values are compared with information relating to the functional properties and topological arrangement of network elements relevant to provision of a service, said information being stored in a network element database, for inadmissible deviations, and
in the event of an inadmissible deviation, a message is generated about a reduction in service capacity, giving details of the service concerned,
when the computer program is running in the data processing system.
